(19) United States
(12) Patent Application Publication
(10) Pub. No.: US 2026/0070338 A1
(43) Pub. Date: Mar. 12, 2026

(54) LIQUID EJECTION APPARATUS

(71) Applicant: SEIKO EPSON CORPORATION, Tokyo (JP)

(72) Inventors: Hiroshi NOSE, SHIOJIRI-SHI (JP); Tomoji SUZUKI, MATSUMOTO-SHI (JP); Takanori MATSUDA, SHIOJIRI-SHI (JP)

(21) Appl. No.: 19/317,730

(22) Filed: Sep. 3, 2025

(30) Foreign Application Priority Data
Sep. 6, 2024 (JP) 2024-153633

(51) Int. Cl. B41J 2/165; B41J 25/00; B41J 29/13

(52) U.S. Cl. CPC B41J 2/16514; B41J 25/001; B41J 29/13; B41J 2002/16594; B41J 2202/07

(57) ABSTRACT

A liquid ejection apparatus includes a head having a nozzle surface, a carriage that moves along a first direction while supporting the head, a support portion that supports a medium when the head ejects the liquid toward the medium, a maintenance portion that is provided in the first direction with respect to the support portion, and a housing that houses the maintenance portion. The housing includes a housing main body in which an opening portion is formed, and a cover configured to open and close the opening portion. The maintenance portion includes a cap and a wiping portion that is movable to a wiping position where the nozzle surface is wiped and a retracted position farther from the head than the wiping position. The support portion, the cap, the wiping portion located at the wiping position, and the opening portion are arranged in order in the first direction.

The present application is based on, and claims priority from JP Application Serial Number 2024-153633, filed Sep. 6, 2024, the disclosure of which is hereby incorporated by reference herein in its entirety.

### BACKGROUND

### 1. Technical Field

The present disclosure relates to a liquid ejection apparatus.

### 2. Related Art

For example, as in JP-A-2023-23362, there is disclosed a liquid ejection apparatus that includes a liquid ejection portion having a nozzle surface in which a plurality of nozzles that eject a liquid are opened, and a carriage that reciprocates the liquid ejection portion along width directions, and performs printing by ejecting the liquid onto a medium.

In such a liquid ejection apparatus, a maintenance unit that performs maintenance of the liquid ejection portion is provided. For example, the maintenance unit is provided with a cap that covers the nozzle surface such as a suction cap and a standby cap, and a liquid collection device as an example of a wiping portion that wipes the nozzle surface.

JP-A-2023-23362 is an example of the related art.

However, in the liquid ejection apparatus, when an operator manually performs maintenance of the nozzle surface, a work space for maintenance of the nozzle surface is required. Therefore, it is desired to improve the convenience of the operator.

### SUMMARY

A liquid ejection apparatus according to an aspect of the present disclosure includes a head having a nozzle surface in which a plurality of nozzles that eject a liquid are opened, a carriage that moves along a first direction intersecting a vertical direction while supporting the head, a support portion that supports a medium when the head ejects the liquid toward the medium, a maintenance portion that is provided in the first direction with respect to the support portion and performs maintenance on the head, and a housing that houses the maintenance portion, wherein the housing includes a housing main body in which an opening portion is formed, and a cover configured to open and close the opening portion, the maintenance portion includes a cap that covers the nozzle surface, and a wiping portion that is movable to a wiping position where the nozzle surface is wiped and a retracted position farther from the head than the wiping position, and the support portion, the cap, the wiping portion located at the wiping position, and the opening portion are arranged in order in the first direction.

### BRIEF DESCRIPTION OF THE DRAWINGS

FIG. 1 is a perspective view showing a liquid ejection apparatus according to a first embodiment.

FIG. 2 is a perspective view showing a maintenance unit according to the first embodiment.

FIG. 3 is a top view showing the liquid ejection apparatus according to the first embodiment.

FIG. 4 is a top view showing the liquid ejection apparatus according to the first embodiment.

FIG. 5 is a left-side sectional view showing a wiping portion and a nozzle surface according to the first embodiment.

FIG. 6 is a perspective view showing an opening portion according to the first embodiment.

### DESCRIPTION OF EMBODIMENTS

### First Embodiment

Hereinafter, an embodiment of a liquid ejection apparatus will be described with reference to the drawings. In the following description, directions intersecting vertical directions Z are defined as width directions X and directions intersecting the vertical directions Z and the width directions X are defined as front-rear directions Y. One of the width directions X is referred to as a first width direction X1 and the other of the width directions X is referred to as a second width direction X2. One of the front-rear directions Y is referred to as a frontward direction Y1 and the other of the front-rear directions Y is referred to as a rearward direction Y2. The upward direction of the vertical directions Z is referred to as an upward direction Z1, and a downward direction of the vertical directions Z is referred to as a downward direction Z2. The first width direction X1 corresponds to an example of a first direction, and the frontward direction Y1 corresponds to an example of a second direction.

### Configuration of Liquid Ejection Apparatus 11

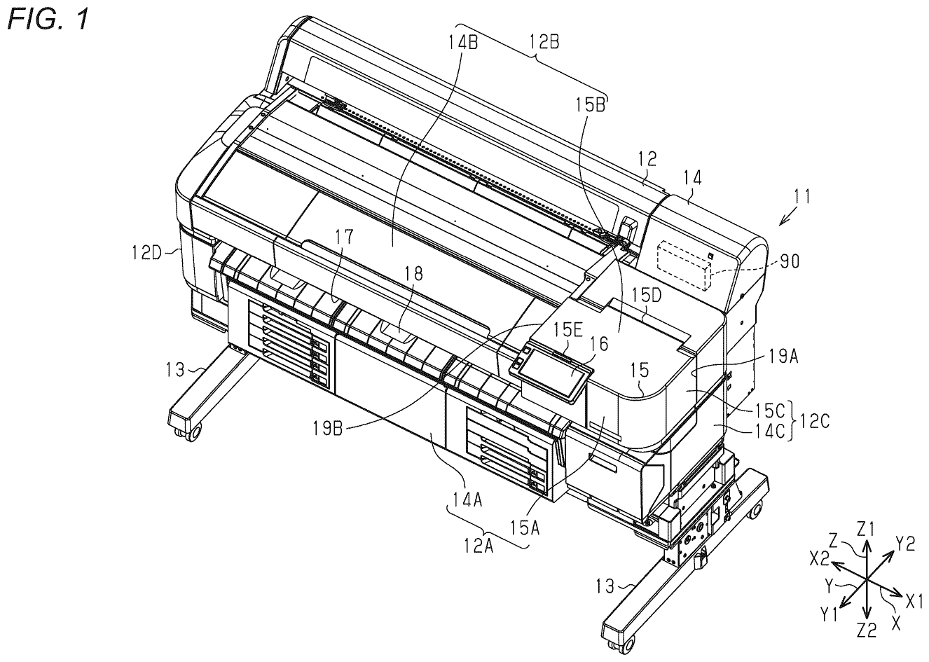

As shown in FIG. 1, a liquid ejection apparatus 11 is configured to perform printing on a medium by ejecting a liquid onto the medium. The liquid may include, for example, ink. The liquid may have, for example, a plurality of kinds of colors. The liquid ejection apparatus 11 may be an inkjet printer.

The liquid ejection apparatus 11 includes a housing 12. The liquid ejection apparatus 11 may include leg portions 13. The housing 12 is configured to house various members forming the liquid ejection apparatus 11. The housing 12 is configured as an exterior of the liquid ejection apparatus 11. The housing 12 may be supported by the leg portions 13.

The housing 12 includes a front surface 12A. The front surface 12A is a surface in the frontward direction Y1 of the housing 12. The housing 12 includes a top surface 12B. The top surface 12B is a surface in the upward direction Z1 of the housing 12.

The housing 12 includes a right side surface 12C and a left side surface 12D. The right side surface 12C is a surface of the housing 12 in the first width direction X1. The left side surface 12D is a surface of the housing 12 in the second width direction X2. The right side surface 12C and the left side surface 12D are surfaces including the vertical directions Z and the front-rear directions Y. The liquid ejection apparatus 11 is an apparatus intended for access from the front surface 12A side.

The housing 12 includes a housing main body 14 and a cover 15. The housing main body 14 includes a main body front surface 14A. The main body front surface 14A is a surface in the frontward direction Y1 of the housing main body 14. The housing main body 14 includes a main body top surface 14B. The main body top surface 14B is a surface in the upward direction Z1 of the housing main body 14. The housing main body 14 includes a first side surface 14C. The first side surface 14C is a surface in the first width direction X1 of the housing main body 14.

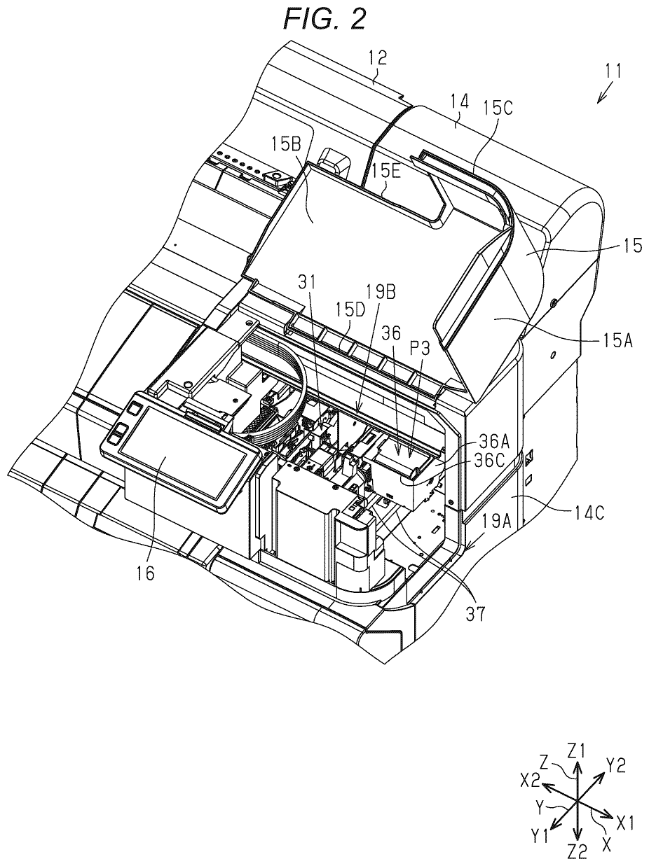

As illustrated in FIGS. 1 and 2, the cover 15 is attached to the housing main body 14. The cover 15 may be rotatably attached to the housing main body 14. The cover 15 is configured to open and close a first opening portion 19A described later. The cover 15 is configured to open and close a second opening portion 19B described later.

The cover 15 includes a cover front surface 15A. The cover front surface 15A is a surface in the frontward direction Y1 of the cover 15 when the cover 15 is closed. The cover 15 includes a cover top surface 15B. The cover top surface 15B is a surface in the upward direction Z1 of the cover 15 when the cover 15 is closed. The cover 15 includes a cover side surface 15C. The cover side surface 15C is a surface in the first width direction X1 of the cover 15.

The front surface 12A includes the main body front surface 14A and the cover front surface 15A. The top surface 12B includes the main body top surface 14B and the cover top surface 15B. The right side surface 12C includes the first side surface 14C and the cover side surface 15C.

The cover 15 includes a rotation shaft 15D and a cutout 15E. The rotation shaft 15D extends in the width directions X at the rear end of the cover top surface 15B. Thus, the cover 15 is configured to be rotatable about the rotation shaft 15D.

The cutout 15E is provided in the cover front surface 15A. The cutout 15E may be provided at the side in the second width direction X2 in the cover front surface 15A. The cutout 15E is provided so as to avoid an operation panel 16 described later when the cover 15 is closed. Accordingly, the operation panel 16 is visible even when the cover 15 is closed.

The liquid ejection apparatus 11 includes the operation panel 16. The operation panel 16 is provided on the top surface 12B. The operation panel 16 is provided at the side in the frontward direction Y1 of the top surface 12B. The operation panel 16 includes an operation portion that can be operated by an operator. The operation panel 16 includes a display portion that displays various types of information. The operation panel 16 may be a touch panel. The operator may include a user and a person other than the user. The other person than the user may include a service person who performs maintenance of the liquid ejection apparatus 11.

As illustrated in FIG. 1, the liquid ejection apparatus 11 includes an ejection opening 17 and an ejection support portion 18. The ejection opening 17 is an opening for ejecting the medium after printing. The ejection opening 17 is provided in the front surface 12A. The ejection opening 17 is provided to extend in the width directions X.

The ejection support portion 18 is provided on the front surface 12A. The ejection support portion 18 may be configured to extend from the front surface 12A in the rearward direction Y2. The ejection support portion 18 may be configured to protrude from the front surface 12A in the frontward direction Y1. The ejection support portion 18 is provided to extend in the width directions X. The ejection support portion 18 is configured to support the medium onto which the liquid is ejected.

The liquid ejection apparatus 11 includes a control portion 90. The control portion 90 performs integrated control of the liquid ejection apparatus 11. The control portion 90 controls various types of operations executed by the liquid ejection apparatus 11. The control portion 90 can be configured as a circuit including a: one or more processors that execute various kinds of processing in accordance with a computer program, B: one or more dedicated hardware circuits that execute at least a part of the various kinds of processing, or y: a combination of a and B. The hardware circuit is, for example, an application-specific integrated circuit. The processor includes a CPU and a memory such as a RAM and a ROM, and the memory stores program codes or commands configured to cause the CPU to execute processing. The memory, that is, a computer-readable medium, includes any readable medium that can be accessed by a general-purpose or dedicated computer.

The control portion 90 displays various types of information on the operation panel 16. The control portion 90 receives an instruction by the operator through the operation panel 16. The liquid ejection apparatus 11 may be communicable with a terminal device (not illustrated). The control portion 90 may receive an instruction by the operator from the terminal device.

### Configuration of Housing Main Body 14

As illustrated in FIG. 2, the housing main body 14 includes a first opening portion 19A and a second opening portion 19B. The first opening portion 19A is provided at the side in the first width direction X1 in the housing main body 14. The first opening portion 19A is provided in the first side surface 14C. That is, the housing main body 14 is provided with the first opening portion 19A in the first width direction X1.

The first opening portion 19A is provided in the first width direction X1 with respect to a maintenance portion 31 described later. The first opening portion 19A is covered by the cover side surface 15C when the cover 15 is closed. The first opening portion 19A is provided so as to expose a maintenance portion 31 described later from the first side surface 14C side when the cover 15 is opened. In this way, the cover 15 can open and close the first opening portion 19A. The cover 15 covers the first opening portion 19A at least from the first width direction X1.

The second opening portion 19B is provided in the main body top surface 14B. The second opening portion 19B is provided at the side in the first width direction X1 in the main body top surface 14B. The second opening portion 19B is provided at the side in the frontward direction Y1 in the main body top surface 14B. That is, the second opening portion 19B is provided at the side in the first width direction X1 and in the frontward direction Y1 in the main body top surface 14B.

The second opening portion 19B is provided in the rearward direction Y2 of the operation panel 16. The second opening portion 19B is provided in the upward direction Z1 with respect to the maintenance portion 31 described later. The second opening portion 19B is covered by the cover top surface 15B when the cover 15 is closed. The second opening portion 19B is provided so as to expose the maintenance portion 31 described later from the side in the upward direction Z1 when the cover 15 is opened. In this way, the cover 15 can open and close the second opening portion 19B.

The first opening portion 19A and the second opening portion 19B may communicate with each other. The first opening portion 19A and the second opening portion 19B may communicate with each other over the main body top surface 14B and the first side surface 14C at the side in the first width direction X1 in the housing main body 14 and at the side in the upward direction Z1 of the housing main body 14. The first opening portion 19A corresponds to an example of an opening portion.

### Regions of Liquid Ejection Apparatus 11

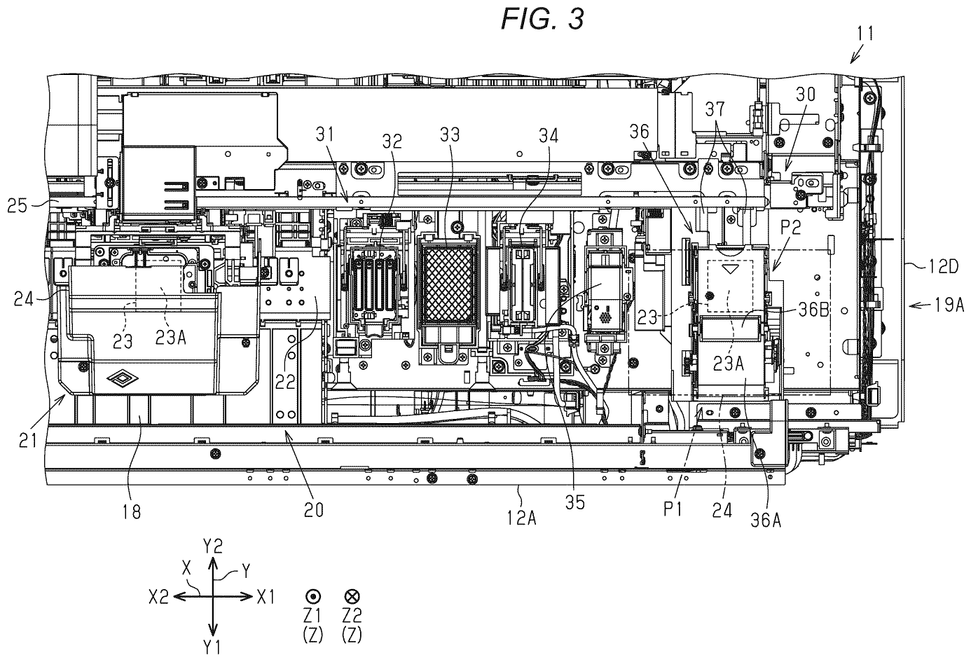

As illustrated in FIG. 3, the liquid ejection apparatus 11 includes a printing region 20 and a maintenance region 30. The printing region 20 is a region for performing printing on the medium. The maintenance region 30 is a region for performing maintenance of a head 23 described later.

The printing region 20 is provided at the center of the liquid ejection apparatus 11. The maintenance region 30 is provided in the first width direction X1 with respect to the center of the liquid ejection apparatus 11. That is, the maintenance region 30 is provided in the first width direction X1 with respect to the printing region 20.

### Configuration of Liquid Ejection Portion 21

The liquid ejection apparatus 11 includes a liquid ejection portion 21 and a support portion 22. The liquid ejection apparatus 11 includes a conveyance portion (not illustrated). The conveyance portion is configured to convey the medium. The conveyance portion is configured to convey the medium toward the frontward direction Y1 in the printing region 20.

The liquid ejection portion 21 is configured to eject the liquid onto the medium. The liquid ejection portion 21 is configured to eject the liquid onto a region of the medium supported by the support portion 22 in the printing region 20. The liquid ejection portion 21 is configured to eject the liquid onto the medium conveyed in the frontward direction Y1 in the printing region 20.

The liquid ejection portion 21 includes the head 23, a carriage 24, and a carriage guide 25. That is, the liquid ejection apparatus 11 includes the head 23, the carriage 24, and the carriage guide 25.

The head 23 is configured to eject the liquid. The head 23 of the present embodiment ejects the liquid toward the downward direction Z2. The head 23 is configured to be supported by a bottom surface of the carriage 24.

The head 23 includes a nozzle surface 23A. The nozzle surface 23A is a surface in which a plurality of nozzles (not illustrated) that eject the liquid are opened. The nozzle surface 23A is provided on the bottom surface of the head 23 so as to face the downward direction Z2. The head 23 is configured to eject the liquid from the plurality of nozzles.

The carriage 24 is configured to support the head 23. The carriage 24 is supported by the carriage guide 25. The carriage guide 25 is configured to extend in the width directions X. The carriage guide 25 is configured to extend in the width directions X over the printing region 20 and the maintenance region 30. The carriage 24 is configured to reciprocate along the width directions X along the carriage guide 25 by a driving force from a carriage drive portion (not illustrated).

Accordingly, the carriage 24 is configured to move along the width directions X while supporting the head 23. That is, the carriage 24 is configured to move along the first width directions X1 while supporting the head 23. The carriage 24 is configured to move along the width directions X in the printing region 20 and the maintenance region 30.

The carriage 24 passes through a position facing the medium supported by the support portion 22, by reciprocating along the width directions X in the printing region 20. The head 23 is configured to eject the liquid in the printing region 20 along the width directions X. The head 23 prints an image on the medium by ejecting the liquid onto the medium.

The support portion 22 is configured to support the medium. The support portion 22 is provided to extend in the width directions X in the printing region 20. The support portion 22 is configured to support the medium conveyed by the conveyance portion in the printing region 20. The support portion 22 is provided at a position facing the head 23 in the printing region 20. The support portion 22 is configured to support the medium when the head 23 ejects the liquid toward the medium.

### Configuration of Maintenance Portion 31

The liquid ejection apparatus 11 includes the maintenance portion 31. The maintenance portion 31 is provided in the maintenance region 30. The maintenance portion 31 is provided at a position facing the head 23 in the maintenance region 30. The maintenance portion 31 is provided in the first width direction X1 with respect to the support portion 22 in the maintenance region 30. The maintenance portion 31 is configured to perform maintenance of the head 23.

The maintenance portion 31 includes a moisturizing cap 32, a flushing portion 33, a suction cap 34, a deairing portion 35, and a wiping portion 36. In the printing region 20 and the maintenance region 30, the support portion 22, the moisturizing cap 32, the flushing portion 33, the suction cap 34, the deairing portion 35, and the wiping portion 36 are disposed in order in the first width direction X1.

The first opening portion 19A is provided in the first width direction X1 of the maintenance portion 31. Specifically, the first opening portion 19A is provided in the first width direction X1 with respect to the wiping portion 36. As described above, the support portion 22, the moisturizing cap 32, the flushing portion 33, the suction cap 34, the deairing portion 35, the wiping portion 36 located at a wiping position P2 described later, and the first opening portion 19A are arranged in order in the first width direction X1.

The individual configurations of the maintenance portion 31 may be disposed within the first opening portion 19A in the front-rear directions Y in a top view. That is, the moisturizing cap 32, the flushing portion 33, the suction cap 34, the deairing portion 35, and the wiping portion 36 may be disposed within the first opening portion 19A in the front-rear directions Y in the top view.

The carriage 24 is disposed at a position facing the individual configurations of the maintenance region 30 while supporting the head 23, and thus the individual configurations of the maintenance portion 31 perform maintenance of the nozzle surface 23A.

In particular, the carriage 24 is movable to a first position P1. The first position P1 is a position at which the nozzle surface 23A can face the wiping portion 36 disposed at the wiping position P2 described later. The first position P1 is a position where the nozzle surface 23A can be wiped by the wiping portion 36.

The moisturizing cap 32 is provided at a position facing the head 23 in the maintenance region 30. The moisturizing cap 32 is located at the inner side than the suction cap 34 in the width directions X.

The moisturizing cap 32 comes into contact with the head 23 to form a space that communicates with the nozzles. The moisturizing cap 32 caps the head 23 by coming into close contact with the head 23. The moisturizing cap 32 covers the nozzle surface 23A. The moisturizing cap 32 may be configured to be movable up and down. The moisturizing cap 32 may be configured to cover the nozzle surface 23A by moving up.

The moisturizing cap 32 moisturizes the nozzles by capping the head 23. That is, the moisturizing cap 32 is a cap that moisturizes the head 23 by covering the nozzle surface 23A while facing the head 23. The moisturizing cap 32 corresponds to an example of a cap.

The flushing portion 33 is provided at a position facing the head 23 in the maintenance region 30. The flushing portion 33 is located at the outer side than the moisturizing cap 32 in the width directions X. The flushing portion 33 is located at the inner side than the suction cap 34 in the width directions X. The flushing portion 33 is located between the wiping portion 36 and the moisturizing cap 32.

The flushing portion 33 is configured to receive the liquid ejected from the head 23. The flushing portion 33 may receive the liquid ejected from the head 23 by pressurization. That is, the flushing portion 33 may receive the liquid ejected by pressurized cleaning.

The pressurized cleaning ejects the liquid from inside of the head 23 by pressurizing the liquid within the head 23. The pressurized cleaning is maintenance for forcibly ejecting the liquid from the nozzles to eject air bubbles, foreign substances, and the like from the nozzles along with the liquid within the head 23.

The flushing portion 33 may receive the liquid ejected by dummy ejection. The dummy ejection is an operation of ejecting the liquid from the nozzles to suppress clogging of the nozzles. The dummy ejection is also referred to as flushing. The dummy ejection, for example, ejects a liquid having increased viscosity from the nozzles. The flushing portion 33 receives the liquid ejected from the head 23 facing itself.

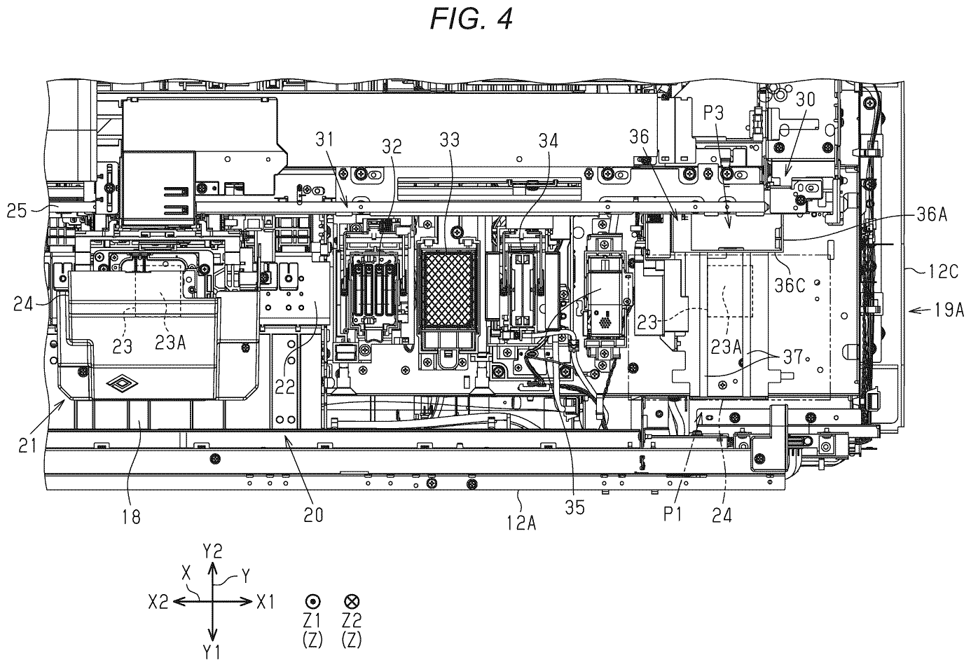

The suction cap 34 is provided at a position facing the head 23 in the maintenance region 30. The suction cap 34 is located at the outer side than the moisturizing cap 32 in the width directions X. The suction cap 34 is located between the wiping portion 36 and the moisturizing cap 32 in the first width direction X1. In FIGS. 3 and 4, the suction cap 34 is covered with a cap cover, but the cap cover is removed during actual use. As a result, the suction cap 34 is opened.

The suction cap 34 comes into contact with the head 23 to form a space that communicates with the nozzles. The suction cap 34 caps the head 23 by coming into close contact with the head 23. The suction cap 34 covers the nozzle surface 23A. The suction cap 34 may be configured to be movable up and down. The suction cap 34 may be configured to cover the nozzle surface 23A by moving up.

The suction cap 34 suctions the liquid from the head 23 by suction using a suction pump (not illustrated) while capping the nozzle surface 23A. That is, the suction cap 34 is a cap that suctions the liquid from the head 23 while facing the head 23 and covering the nozzle surface 23A. The suction cap 34 corresponds to an example of the cap.

In this manner, the suction cleaning of the head 23 is performed by setting the inside of the suction cap 34 at negative pressure by suctioning the inside of the suction cap 34. The suction cleaning is performed on the head 23 not filled with the liquid, and thus the head 23 can be filled with the liquid. The suction cleaning is performed on the head 23 filled with the liquid, and thus air bubbles, foreign substances, and the like in the head 23 can be ejected. In this manner, the suction cap 34 is configured to receive the liquid ejected from the head 23 along with the suction cleaning.

The deairing portion 35 is provided at a position facing the head 23 in the maintenance region 30. The deairing portion 35 is located at the outer side than the moisturizing cap 32 and the suction cap 34 in the width directions X. The deairing portion 35 is configured to deair a part of a path for supplying the liquid to the head 23. The deairing portion 35 may remove air bubbles or the like contained in the liquid from a part of the path for supplying the liquid. The deairing portion 35 may be configured to deair the head 23. The deairing portion 35 may remove air bubbles and the like contained in the liquid from the head 23.

The wiping portion 36 is configured to wipe the liquid from the head 23. The wiping portion 36 may be a wiper unit. The wiping portion 36 is configured to wipe the nozzle surface 23A at a position facing the head 23. The wiping portion 36 performs wiping to wipe the nozzle surface 23A.

### Configuration of Wiping Portion 36

As illustrated in FIGS. 3 and 4, the wiping portion 36 includes a wiper carriage 36A and a wiper 36B. The wiper carriage 36A is configured to support the wiper 36B. The wiper carriage 36A includes one end portion 36C. The one end portion 36C is an end portion of the wiping portion 36 in the frontward direction Y1 in the top view. The maintenance portion 31 includes wiper rails 37. The wiper carriage 36A is supported by the wiper rails 37. The wiper rails 37 are configured to extend in the front-back directions Y. The wiper rails 37 includes a pair of rail members arranged in the width directions X. The number of wiper rails 37 may be one, three, or more.

The wiper carriage 36A is configured to reciprocate along the wiper rails 37 by a driving force from a wiper carriage drive portion (not illustrated). Accordingly, the wiper carriage 36A is configured to move along the front-back directions Y while supporting the wiper 36B.

The wiper 36B is supported by the wiper carriage 36A so as to protrude from the wiper carriage 36A in the upward direction Z1. The wiper 36B wipes the nozzle surface 23A. The wiper 36B may wipe the nozzle surface 23A by rotating in the front-rear directions Y.

The wiping portion 36 is configured to be movable along the front-rear directions Y to the wiping position P2 illustrated in FIG. 3 and a retracted position P3 illustrated in FIG. 4. As illustrated in FIG. 3, the wiping position P2 is a position where the wiping portion 36 faces the head 23 when the carriage 24 is disposed at the first position P1. The wiping position P2 is a position at which the nozzle surface 23A is wiped. That is, the wiping portion 36 performs maintenance of the head 23 by wiping a waste liquid from the nozzle surface 23A at the wiping position P2. The wiping portion 36 performs wiping to wipe the nozzle surface 23A. The wiping portion 36 performs wiping to wipe the nozzle surface 23A when the wiper carriage 36A is at the wiping position P2 and the head 23 is at the first position P1.

The wiping portion 36 may be movable in the front-rear directions Y when performing wiping. The wiping portion 36 may be movable in the front-back directions Y while being supported by the wiper rails 37, for example. The wiping portion 36 may wipe the nozzle surface 23A by moving in the front-rear directions Y. That is, the wiping portion 36 may wipe the head 23 along the frontward direction Y1. The wiping portion 36 is located at the outer side than the moisturizing cap 32 and the suction cap 34 in the width directions X.

As shown in FIG. 4, the retracted position P3 is a position in the rearward direction Y2 of the wiping position P2. The retracted position P3 is a position where the wiping portion is retracted in the rearward direction Y2 of the maintenance region 30. When the carriage 24 is disposed at the first position P1, the retracted position P3 is located farther from the head 23 than the wiping position P2 in the rearward direction Y2. The wiping portion 36 is configured not to wipe the nozzle surface 23A at the retracted position P3.

The movement path of the wiping portion 36 when the wiping portion 36 wipes the nozzle surface 23A may overlap a part of the movement path of the wiping portion 36 when the wiping portion 36 moves between the wiping position P2 and the retracted position P3. The movement path of the wiping portion 36 is a path along the wiper rails 37 as described above, and the drive source of the wiping portion 36 is the wiper carriage drive portion (not illustrated) as described above. In this manner, the wiping portion 36 wipes the nozzle surface 23A along the movement path for moving between the wiping position P2 and the retracted position P3.

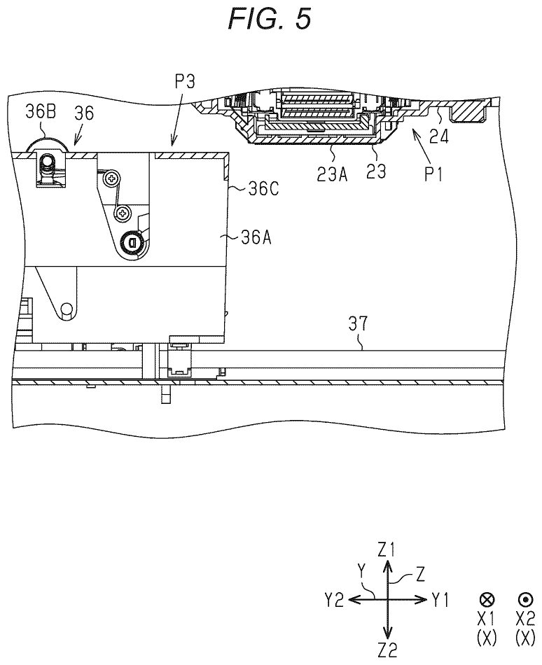

As illustrated in FIG. 5, when the carriage 24 is disposed at the first position P1 and the wiping portion 36 is disposed at the retracted position P3, the one end portion 36C does not overlap the nozzle surface 23A in the vertical directions Z. That is, when the wiping portion 36 is disposed at the retracted position P3, the one end portion 36C does not overlap the nozzle surface 23A in the top view.

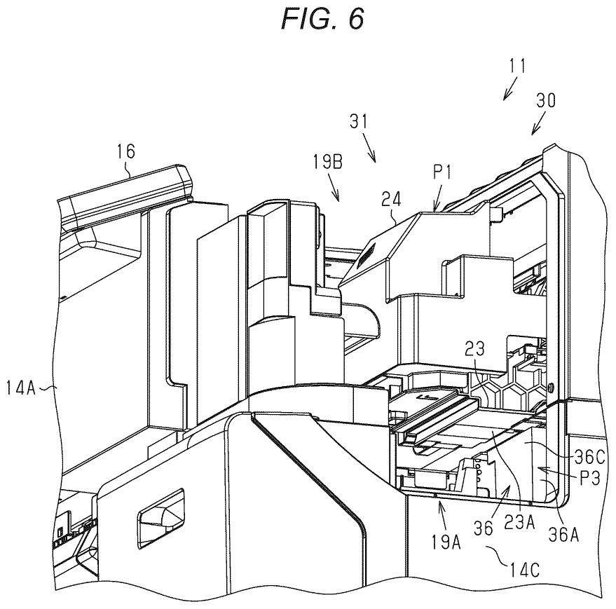

As illustrated in FIG. 6, a space is provided in the downward direction Z2 of the nozzle surface 23A when the carriage 24 is disposed at the first position P1 and the wiping portion 36 is disposed at the retracted position P3. The wiping portion 36 is in the space when disposed at the wiping position P2.

The first opening portion 19A is provided to be accessible to the nozzle surface 23A from the side in the first width direction X1 when the carriage 24 is disposed at the first position P1, the wiping portion 36 is disposed at the retracted position P3, and the cover 15 is opened. Specifically, the first opening portion 19A is provided in the first side surface 14C and opens in the downward direction Z2 with respect to the nozzle surface 23A in the vertical directions Z. The first opening portion 19A is provided so that the nozzle surface 23A is within the portion in the front-rear directions Y.

Accordingly, the operator can perform manual maintenance of the nozzle surface 23A via the space, provided by the wiping portion 36 being disposed at the retracted position P3, and the first opening portion 19A.

### Details of Control of Liquid Ejection Apparatus 11

In the standby state, the control portion 90 disposes the carriage 24 at a position where the nozzle surface 23A faces the moisturizing cap 32 in the vertical directions Z. The control portion 90 moves up the moisturizing cap 32 so as to cap the nozzle surface 23A.

When receiving a printing instruction from the user, the control portion 90 moves down the moisturizing cap 32 so as to release the capping of the nozzle surface 23A. The control portion 90 moves the carriage 24 in the first width direction X1 to a position where the nozzle surface 23A faces the flushing portion 33 in the vertical directions Z. The control portion 90 controls the liquid ejection portion 21 to flush.

Then, the control portion 90 moves the carriage 24 in the second width direction X2 from the position where the nozzle surface 23A faces the flushing portion 33 in the vertical directions Z. In this case, the control portion 90 moves the carriage 24 to the printing region 20 through the position where the nozzle surface 23A faces the moisturizing cap 32 in the vertical directions Z.

As described above, in the liquid ejection apparatus 11, the moisturizing cap 32 can be displaced between the flushing portion 33 and the printing region 20 in the width directions X and a distance to the extent that the carriage 24 can be accelerated can be secured. As a result, the carriage 24 can move in the second width direction X2 at the same speed in the printing region 20.

The control portion 90 reciprocates the carriage 24 along the width directions X, ejects the liquid from the liquid ejection portion 21 onto the medium, and conveys the medium. Accordingly, the control portion 90 performs printing on the medium according to the printing instruction by the user.

Even during printing, the control portion 90 moves the carriage 24 in the first width direction X1 to the position where the nozzle surface 23A faces the flushing portion 33 in the vertical directions Z, and controls the liquid ejection portion 21 to flush.

When an execution condition of the suction cleaning is satisfied, the control portion 90 moves the carriage 24 in the first width direction X1 to a position where the nozzle surface 23A faces the suction cap 34 in the vertical directions Z. The execution condition of the suction cleaning may be satisfied during printing, or may be satisfied at the start of printing and at the end of printing. The control portion 90 moves up the suction cap 34 so as to cap the nozzle surface 23A, thereby bringing the suction cap 34 into contact with the head 23. The control portion 90 performs suction cleaning by suction using a suction pump (not illustrated) with the suction cap 34 capping the nozzle surface 23A.

When the suction cleaning ends, the control portion 90 moves down the suction cap 34 so as to release the capping of the nozzle surface 23A. The control portion 90 moves the carriage 24 to the first position P1. The control portion 90 performs wiping by moving the wiping portion 36 in the front-rear directions Y at the wiping position P2. When the wiping ends, the control portion 90 moves the carriage 24 in the second width direction X2. When the wiping ends, the control portion 90 may restart the printing or may end the printing.

When the printing ends, the control portion 90 moves the carriage 24 from the printing region 20 to the position where the nozzle surface 23A faces the moisturizing cap 32 in the vertical directions Z. The control portion 90 moves up the moisturizing cap 32 so as to cap the nozzle surface 23A, thereby bringing the moisturizing cap 32 into contact with the head 23 to perform control during standby.

The moisturizing cap 32 is disposed at a position close to the printing region 20 in the maintenance region 30. Therefore, when the printing is completed, the movement distance of the carriage 24 can be shortened.

As described above, when the cover 15 is opened in the standby state, the maintenance portion 31 is exposed through the second opening portion 19B. Accordingly, the operator can perform maintenance of the maintenance portion 31 from the upward direction Z1.

During standby, the control portion 90 moves the carriage 24 to the first position P1 and moves the wiping portion 36 to the retracted position P3 in response to an instruction from the operator. That is, the carriage 24 is configured to move to the first position P1 in response to an instruction from the operator. The wiping portion 36 moves to the retracted position P3 in response to an instruction from the operator. Accordingly, manual maintenance of the nozzle surface 23A can be performed from the first side surface 14C side through the first opening portion 19A.

### Functions and Effects of First Embodiment

Functions and effects of the first embodiment will be described.

(1-1) The support portion 22, the moisturizing cap 32, the suction cap 34, the wiping portion 36 located at the wiping position P2, and the first opening portion 19A are arranged in order in the first width direction X1. According to the configuration, since the wiping portion 36 moves from the wiping position P2 to the retracted position P3, the wiping portion 36 is not disposed at the wiping position P2. The carriage 24 is moved to the first position P1, and thus a work space can be provided at a position facing the nozzle surface 23A. The operator can manually perform maintenance on the nozzle surface 23A using the work space from the first opening portion 19A without interfering with the support portion 22 or the moisturizing cap 32. As a result, the workability of maintenance by the operator can be improved. In addition, the workability of maintenance by the operator can be improved without providing the first opening portion 19A for manually maintaining the nozzle surface 23A in the vicinity of the support portion 22.

(1-2) The wiping portion 36 is movable to the wiping position P2 and the retracted position P3 along the frontward direction Y1 intersecting the vertical directions Z and the first width direction X1, and wipes the head 23 along the frontward direction Y1. According to the configuration, the wiping portion 36 can perform the movement between the wiping position P2 and the retracted position P3 and the wiping of the nozzle surface 23A along the same frontward direction Y1. Accordingly, similarly to the wiping of the nozzle surface 23A, a work space can be provided at the position facing the nozzle surface 23A by performing the movement between the wiping position P2 and the retracted position P3.

(1-3) The liquid ejection apparatus 11 includes the suction cap 34 that suctions the liquid from the head 23 while covering the nozzle surface 23A. According to the configuration, air bubbles, foreign substances, and the like in the head 23 can be ejected by suctioning the liquid from the head 23 filled with the liquid. Therefore, not only the nozzle surface 23A but also the insides of the plurality of nozzles can be cleaned. By wiping the nozzle surface 23A after suctioning the liquid from the head 23, dropping of the liquid inside the liquid ejection apparatus 11 can be suppressed. In addition, the operator can manually perform maintenance on the nozzle surface 23A using the work space from the first opening portion 19A in the first width direction X1 without interfering with the suction cap 34. As a result, the workability of maintenance by the operator can be improved.

(1-4) The liquid ejection apparatus 11 includes the moisturizing cap 32 that moisturizes the head 23 by covering the nozzle surface 23A. According to the configuration, the nozzles can be moisturized by covering the head 23 with the moisturizing cap 32. Therefore, the liquid in the head 23 can be prevented from being dried and fixed. In addition, the operator can manually perform maintenance on the nozzle surface 23A using the work space from the first opening portion 19A in the first width direction X1 without interfering with the moisturizing cap 32. As a result, the workability of maintenance by the operator can be improved.

(1-5) The liquid ejection apparatus 11 includes the moisturizing cap 32 and the suction cap 34. According to the configuration, both ejection of air bubbles, foreign substances, and the like in the head 23 and moisturization of the nozzles can be performed. In addition, the operator can manually perform maintenance on the nozzle surface 23A using the work space from the first opening portion 19A in the first width direction X1 without interfering with the suction cap 34 or the moisturizing cap 32. As a result, the workability of maintenance by the operator can be improved.

(1-6) The suction cap 34 is located between the wiping portion 36 and the moisturizing cap 32 in the first width direction X1. According to the configuration, the wiping portion 36 is disposed at a position closer to the suction cap 34 than the moisturizing cap 32 in the first width direction X1. Therefore, the movement distance of the carriage 24 after the suction of the liquid from the head 23 and before the wiping of the nozzle surface 23A can be shortened. Accordingly, the maintenance time of the head 23 can be shortened.

(1-7) The liquid ejection apparatus 11 includes the flushing portion 33 that receives the liquid ejected from the head 23. The flushing portion 33 is located between the wiping portion 36 and the moisturizing cap 32. According to the configuration, in the first width direction X1, the flushing portion 33 is disposed at a position closer to the moisturizing cap 32 and the support portion 22 than the wiping portion 36. Therefore, the time for moving the nozzle surface 23A from the position where the nozzle surface 23A faces the moisturizing cap 32 and the support portion 22 to the position where the nozzle surface 23A faces the flushing portion 33 can be shortened. Accordingly, the printing time of the liquid ejection apparatus 11 can be shortened.

In addition, when the nozzle surface 23A is disposed at the position where the nozzle surface faces the flushing portion 33, the distance for accelerating the carriage 24 can be secured to the position where the nozzle surface 23A faces the support portion 22. Accordingly, the carriage 24 can be moved at a constant speed at the position where the nozzle surface 23A faces the support portion 22. As a result, a decrease in printing quality can be suppressed. Therefore, the convenience for the user can be increased.

(1-8) The wiping portion 36 moves to the retracted position P3 in response to an instruction from the operator. The carriage 24 moves to the first position P1 at which the nozzle surface 23A can be wiped according to an instruction from the operator. According to the configuration, the work space can be provided at the position facing the nozzle surface 23A with the carriage 24 moved to the first position P1 and the wiping portion 36 moved to the retracted position P3 by the operator's intention. As a result, the workability of maintenance by the operator can be improved.

(1-9) The first opening portion 19A opens in the downward direction Z2 with respect to the nozzle surface 23A in the vertical directions Z. According to the configuration, the manual maintenance of the nozzle surface 23A is easier through the first opening portion 19A. As a result, the workability of maintenance by the operator can be improved.

(1-10) When the wiping portion 36 is disposed at the retracted position P3, the one end portion 36C in the frontward direction Y1 intersecting the first width direction X1 in the top view does not overlap the nozzle surface 23A. According to the configuration, the interference by the wiping portion 36 disposed at the retracted position P3 can be suppressed, and the operator can manually perform maintenance on the nozzle surface 23A using the work space from the first opening portion 19A in the first width direction X1. As a result, the workability of maintenance by the operator can be improved.

(1-11) The housing main body 14 has the first side surface 14C in the first width direction X1. The first opening portion 19A is provided in the first side surface 14C. The cover 15 covers the first opening portion 19A at least from the first side surface 14C. According to the configuration, the operator can manually perform maintenance on the nozzle surface 23A from the side in the first width direction X1 through the first opening portion 19A provided in the first side surface 14C, by opening the cover 15. As a result, the workability of maintenance by the operator can be improved. In addition, entry of foreign substances into the housing 12 can be suppressed by closing the cover 15.

### MODIFICATION EXAMPLES

The present embodiments can be implemented with the modifications described below. The present embodiment and the following modification examples can be implemented in combination with each other as long as no technical inconsistencies are involved.

When an error occurs, the control portion 90 may move the carriage 24 to the first position P1 and move the wiping portion 36 to the retracted position P3. The control portion 90 may move the carriage 24 to the first position P1 and move the wiping portion 36 to the retracted position P3 regardless of the instruction by the operator.

The control portion 90 may dispose the carriage 24 at the position where the nozzle surface 23A faces the moisturizing cap 32 in the vertical directions Z according to an instruction of the operator. The control performed by the control portion 90 may be performed by an instruction from the operator.

The operation panel 16 may be provided on the front surface 12A. The operation panel 16 may be configured to be rotatable about a shaft extending in the width directions X. The operation panel 16 may be provided at a position away from the closed cover 15.

The rotation shaft 15D may be a shaft extending in the width directions X at the front end of the cover top surface 15B. The cover 15 may be rotatable about a rotation shaft along the front-rear directions Y. The cover 15 may be rotatable about a rotation shaft along the vertical directions Z. The cover 15 may open the first opening portion 19A by sliding. The cover 15 may be detachable. The cover 15 may be slidably attached to the housing main body 14. The cover 15 may be detachably attached to the housing main body 14.

The cover 15 may have a size larger than the first opening portion 19A or may have the same size as the first opening portion 19A as long as the cover 15 can cover at least the first opening portion 19A.

The carriage 24 may be configured to be movable up and down in the vertical directions Z at the first position P1. When the carriage 24 is configured to be movable up and down in the vertical directions Z at the first position P1, the first opening portion 19A may open in the downward direction Z2 with respect to the nozzle surface 23A of the carriage 24 that moves up and down in the vertical directions Z.

When a work space is provided in the downward direction Z2 of the nozzle surface 23A by disposing the carriage 24 at the first position P1 and disposing the wiping portion 36 at the retracted position P3, the first opening portion 19A may not be opened in the downward direction Z2 with respect to the nozzle surface 23A.

With a work space provided in the downward direction Z2 with respect to the nozzle surface 23A, when the wiping portion 36 is disposed at the retracted position P3, the one end portion 36C may overlap the nozzle surface 23A in the top view.

The opening portion may include at least the first opening portion 19A. The first opening portion 19A and the second opening portion 19B may not communicate with each other. The first opening portion 19A and the second opening portion 19B may be covered with separate covers.

The liquid ejection apparatus 11 may store the liquid collected by at least one of the flushing unit 33, the suction cap 34, and the wiping portion 36 as a waste liquid in a waste liquid storage portion (not illustrated).

The maintenance portion 31 may include a component other than the moisturizing cap 32, the flushing portion 33, the suction cap 34, the deairing portion 35, and the wiping portion 36. The maintenance portion 31 may not include at least one configuration of the moisturizing cap 32, the flushing portion 33, the suction cap 34, the deairing portion 35, and the wiping portion 36.

The moisturizing cap 32, the flushing portion 33, the suction cap 34, and the deairing portion 35 may be disposed in any order in the first width direction X1. The flushing portion 33 and the deairing portion 35 may be provided in the second width direction X2 with respect to the support portion 22. The maintenance portion 31 may not include at least one of the flushing portion 33 and the deairing portion 35. The maintenance portion 31 may not include either the moisturizing cap 32 or the suction cap 34. The moisturizing cap 32 may be provided in the second width direction X2 with respect to the support portion 22.

The maintenance portion 31 may be provided in the second width direction X2 with respect to the support portion 22. In this case, the second width direction X2 may be an example of the first direction. The maintenance portion 31 may be provided separately from the support portion 22 in both the first width direction X1 and the second width direction X2.

The first side surface 14C may be a surface of the housing main body 14 in the second width direction X2. The support portion 22, the moisturizing cap 32, the flushing portion 33, the suction cap 34, the deairing portion 35, the wiping portion 36 located at the wiping position P2, and the first opening portion 19A may be arranged in order in the second width direction X2. That is, in the disclosure according to the present embodiment, the arrangement of the members may be reversed between the first width direction X1 and the second width direction X2. In this case, the second width direction X2 may be an example of the first direction.

The retracted position P3 may be in the downward direction Z2 with respect to the wiping position P2. The wiping portion 36 may wipe the nozzle surface 23A by moving in the width directions X. The wiping portion 36 may not wipe the nozzle surface 23A along the front-rear directions Y. In this case, for example, by moving the carriage 24 in the width directions X and bringing the nozzle surface 23A into contact with the wiper 36B that is stopped, the wiping portion 36 may wipe the nozzle surface 23A.

The wiping portion 36 may wipe the nozzle surface 23A by moving in directions other than the front-rear directions Y. The wiping of the nozzle surface 23A by the wiper 36B may not be accompanied by the movement of the wiping portion 36. For example, only the wiper 36B may rotate, or wiping may be performed by driving a belt instead of the wiper 36B.

The expression “at least one of” used in the present specification means one or more of desired choices. As an example, the expression “at least one of” used in the present specification means only one choice or both of two choices when the number of choices is two. As another example, the expression “at least one of” used in the present specification means only one choice or a combination of any two or more choices when the number of the choices is three or more.

### APPENDICES

Technical ideas understood from the embodiments and the modification examples described above, and the functions and effects thereof will be described below. The technical ideas and the functions and effects thereof can be combined with each other as long as no technical inconsistencies are involved.

[1] A liquid ejection apparatus includes a head having a nozzle surface in which a plurality of nozzles that eject a liquid are opened, a carriage that moves along a first direction intersecting a vertical direction while supporting the head, a support portion that supports a medium when the head ejects the liquid toward the medium, a maintenance portion that is provided in the first direction with respect to the support portion and performs maintenance on the head, and a housing that houses the maintenance portion, wherein the housing includes a housing main body in which an opening portion is formed, and a cover configured to open and close the opening portion, the maintenance portion includes a cap that covers the nozzle surface, and a wiping portion that is movable to a wiping position where the nozzle surface is wiped and a retracted position farther from the head than the wiping position, and the support portion, the cap, the wiping portion located at the wiping position, and the opening portion are arranged in order in the first direction.

According to the configuration, the wiping portion is movable to the wiping position and the retracted position. The wiping portion is provided in the first direction with respect to the support portion and the cap and in a direction opposite to the first direction with respect to the opening portion, when the wiping portion is disposed at the wiping position. Accordingly, since the wiping portion moves from the wiping position to the retracted position, the wiping portion is not disposed at the wiping position. By moving the carriage so that the nozzle surface faces the wiping position, a work space can be provided at a position facing the nozzle surface. The operator can manually perform maintenance on the nozzle surface using the work space from the opening portion in the first direction without interfering with the support portion or the cap. As a result, the workability of maintenance by the operator can be improved. In addition, the workability of the maintenance by the operator can be improved without providing the opening portion for manually maintaining the nozzle surface in the vicinity of the support portion. Therefore, the convenience of the operator can be improved.

[2] In the liquid ejection apparatus, the wiping portion may be movable to the wiping position and the retracted position along a second direction intersecting the vertical direction and the first direction, and may wipe the head along the second direction.

According to the configuration, the wiping portion can perform the movement between the wiping position and the retracted position and the wiping of the nozzle surface along the same second direction. Accordingly, similarly to the wiping of the nozzle surface, a work space can be provided at the position facing the nozzle surface by performing the movement between the wiping position and the retracted position. Therefore, an increase in size of the apparatus can be suppressed and the convenience of the operator can be improved with the simple configuration.

[3] In the liquid ejection apparatus, the cap may be a suction cap that suctions the liquid from the head while covering the nozzle surface.

According to the configuration, air bubbles, foreign substances, and the like in the head can be ejected by suctioning the liquid from the head filled with the liquid. Therefore, not only the nozzle surface but also the insides of the plurality of nozzles can be cleaned. By wiping the nozzle surface after suctioning the liquid from the head, dropping of the liquid inside the liquid ejection apparatus can be suppressed.

In addition, the operator can manually perform maintenance on the nozzle surface using the work space from the opening portion in the first direction without interfering with the suction cap. As a result, the workability of maintenance by the operator can be improved. Therefore, the convenience of the operator can be improved.

[4] In the liquid ejection apparatus, the cap may be a moisturizing cap that moisturizes the head by covering the nozzle surface.

According to the configuration, the nozzles can be moisturized by covering the head with the moisturizing cap. Therefore, the liquid in the head can be prevented from being dried and fixed.

In addition, the operator can manually perform maintenance on the nozzle surface using the work space from the opening portion in the first direction without interfering with the moisturizing cap. As a result, the workability of maintenance by the operator can be improved. Therefore, the convenience of the operator can be improved.

[5] The liquid ejection apparatus further includes a suction cap that suctions the liquid from the head while covering the nozzle surface, wherein the cap may be a moisturizing cap that moisturizes the head by covering the nozzle surface.

According to the configuration, both ejection of air bubbles, foreign substances, and the like in the head and moisturization of the nozzles can be performed.

In addition, the operator can manually perform maintenance on the nozzle surface using the work space from the opening portion in the first direction without interfering with the suction cap or the moisturizing cap. As a result, the workability of maintenance by the operator can be improved. Therefore, the convenience of the operator can be improved.

[6] In the liquid ejection apparatus, the suction cap may be located between the wiping portion and the moisturizing cap in the first direction.

According to the configuration, the wiping portion is disposed at a position closer to the suction cap than the moisturizing cap in the first direction. Thus, the movement distance of the carriage after the suction of the liquid from the head and before the wiping of the nozzle surface can be shortened. Accordingly, the maintenance time of the head can be shortened. Therefore, the convenience for the user can be increased.

In addition, the moisturizing cap is disposed at a position closer to the support portion than the suction cap and the wiping portion in the first direction. Thus, the time after the liquid is ejected from the plurality of nozzles at the position facing the support portion and before the nozzle surface is covered by the moisturizing cap can be shortened. Therefore, the convenience for the user can be increased.

[7] The liquid ejection apparatus further includes a flushing portion that receives the liquid ejected from the head, wherein the flushing portion may be located between the wiping portion and the moisturizing cap.

According to the configuration, the flushing portion is disposed at a position closer to the moisturizing cap and the support portion than the wiping portion in the first direction. Therefore, the time for moving the nozzle surface from the position where the nozzle surface faces the moisturizing cap and the support portion to the position where the nozzle surface faces the flushing portion can be shortened. Accordingly, the printing time of the liquid ejection apparatus can be shortened. Therefore, the convenience for the user can be increased.

In addition, when the nozzle surface is disposed at the position where the nozzle surface faces the flushing portion before the nozzle surface moves to the position where the nozzle surface faces the support portion, a distance for accelerating the carriage can be secured to the position where the nozzle surface faces the support portion. Accordingly, the carriage can be moved at a constant speed at a position where the nozzle surface faces the support portion. As a result, a decrease in printing quality can be suppressed. Therefore, the convenience for the user can be increased.

[8] In the liquid ejection apparatus, the wiping portion may move to the retracted position according to an instruction by an operator, and the carriage may move to a first position for enabling the nozzle surface to be wiped according to an instruction by the operator.

According to the configuration, the work space can be provided at a position facing the nozzle surface with the carriage moved to the first position and the wiping portion moved to the retracted position by the operator's intention. As a result, the workability of maintenance by the operator can be improved. Therefore, the convenience of the operator can be improved.

[9] In the liquid ejection apparatus, the opening portion may open to below the nozzle surface in the vertical direction.

According to the configuration, the manual maintenance of the nozzle surface is easier through the opening portion. As a result, the workability of maintenance by the operator can be improved. Therefore, the convenience of the operator can be improved.

In the liquid ejection apparatus, when the wiping portion is disposed at the retracted position, one end portion of the wiping portion in a second direction intersecting the first direction in a top view may not overlap the nozzle surface.

According to the configuration, the interference by the wiping portion disposed at the retracted position can be suppressed, and the operator can manually perform maintenance on the nozzle surface using the work space from the opening portion in the first direction. As a result, the workability of maintenance by the operator can be improved. Therefore, the convenience of the operator can be improved.

In the liquid ejection apparatus, the housing main body may have a first side surface in the first direction, the opening portion may be provided in the first side surface, and the cover may cover the opening portion at least from the first side surface.

According to the configuration, the operator can manually perform maintenance on the nozzle surface from the side in the first direction through the opening portion provided in the first side surface, by opening the cover. As a result, the workability of maintenance by the operator can be improved. Therefore, the convenience of the operator can be improved. In addition, entry of foreign substances into the housing can be suppressed by closing the cover.

What is claimed is:

1. A liquid ejection apparatus comprising:
a head having a nozzle surface in which a plurality of nozzles that eject a liquid are opened;
a carriage that moves along a first direction intersecting a vertical direction while supporting the head;
a support portion that supports a medium when the head ejects the liquid toward the medium;
a maintenance portion that is provided in the first direction with respect to the support portion and performs maintenance on the head; and
a housing that houses the maintenance portion, wherein
the housing includes a housing main body in which an opening portion is formed, and a cover configured to open and close the opening portion,
the maintenance portion includes a cap that covers the nozzle surface, and a wiping portion that is movable to a wiping position where the nozzle surface is wiped and a retracted position farther from the head than the wiping position, and
the support portion, the cap, the wiping portion located at the wiping position, and the opening portion are arranged in order in the first direction.

2. The liquid ejection apparatus according to claim 1, wherein
the wiping portion is movable to the wiping position and the retracted position along a second direction intersecting the vertical direction and the first direction, and wipes the head along the second direction.

3. The liquid ejection apparatus according to claim 2, wherein
the cap is a suction cap that suctions the liquid from the head while covering the nozzle surface.

4. The liquid ejection apparatus according to claim 2, wherein
the cap is a moisturizing cap that moisturizes the head by covering the nozzle surface.

5. The liquid ejection apparatus according to claim 2, further comprising a suction cap that suctions the liquid from the head while covering the nozzle surface, wherein
the cap is a moisturizing cap that moisturizes the head by covering the nozzle surface.

6. The liquid ejection apparatus according to claim 5, wherein
the suction cap is located between the wiping portion and the moisturizing cap in the first direction.

7. The liquid ejection apparatus according to claim 4, further comprising a flushing portion that receives the liquid ejected from the head, wherein
the flushing portion is located between the wiping portion and the moisturizing cap.

8. The liquid ejection apparatus according to claim 1, wherein
the wiping portion moves to the retracted position according to an instruction by an operator, and
the carriage moves to a first position for enabling the nozzle surface to be wiped according to an instruction by the operator.

9. The liquid ejection apparatus according to claim 1, wherein
the opening portion opens to below the nozzle surface in the vertical direction.

10. The liquid ejection apparatus according to claim 1, wherein
when the wiping portion is disposed at the retracted position, one end portion of the wiping portion in a second direction intersecting the first direction in a top view does not overlap the nozzle surface.

11. The liquid ejection apparatus according to claim 1, wherein
the housing main body has a first side surface in the first direction,
the opening portion is provided in the first side surface, and
the cover covers the opening portion at least from the first side surface.
